(19) United States
(12) Patent Application Publication
(10) Pub. No.: US 2021/0067648 A1
(43) Pub. Date: Mar. 4, 2021

(54) IMAGE FORMING APPARATUS AND CONTROL METHOD

(71) Applicant: KONICA MINOLTA, INC., Tokyo (JP)

(72) Inventor: Takashi YAMASHITA, Tokyo (JP)

(73) Assignee: KONICA MINOLTA, INC., Tokyo (JP)

(21) Appl. No.: 17/002,806

(22) Filed: Aug. 26, 2020

(30) Foreign Application Priority Data
Aug. 28, 2019 (JP) 2019-155216

(51) Int. Cl. H04N 1/00

(52) U.S. Cl. CPC H04N 1/00726; H04N 1/00724; H04N 1/00663; H04N 1/00694; H04N 1/00604; H04N 1/00689

(57) ABSTRACT

An image forming apparatus to form images on a series of sheets includes: an image forming processor to form an image on each sheet; a reader to read each sheet and to output read data; an inspector to determine a quality of each sheet using the read data; and a controller to discharge each sheet determined as not satisfying a predetermined quality criteria into a second tray other than a first tray specified in a print job. When copies specified in the print job are each constituted by one of the series of sheets and at least one sheet of the series of sheets is on a transport path as at least one remaining sheet, the controller processes each of the at least one remaining sheet in such a way that if the remaining sheet satisfies the predetermined quality criteria, the controller discharges the remaining sheet into the first tray.

### CROSS-REFERENCE TO RELATED APPLICATIONS

The present application claims priority under 35 U.S.C. § 119 to Japanese Patent Application No. 2019-155216, filed Aug. 28, 2019, the contents of which are incorporated herein by reference in their entirety.

### BACKGROUND

### 1. Technological Field

The present invention relates to an image forming apparatus having an inspection function and to a control method.

### 2. Description of the Related Art

Some image forming apparatuses, examples of which includes copiers, printers, multifunction machines, have an automatic inspection function that reads the images printed on sheets of paper (printing medium, sheets) to determine the quality of the sheets and discharges poor quality sheets to a tray (purge tray) other than a tray into which good quality sheets are discharged. Some of such image forming apparatuses have a recovery function that discharges the poor quality sheets and its succeeding printed sheets to the purge tray, and prints the images to be printed on those sheets on other sheets, and checks if the images printed on the other sheets are of good quality and, if they are good, discharges the other sheets into the tray for good quality sheets (tray specified in a print job, or a predetermined tray).

An image forming apparatus having the recovery function is capable of discharging sheets into the predetermined tray in the correct page order and with the correct number of copies specified in the print job. However, even some normal sheets are discharged into the purge tray and wasted.

The image forming apparatus described in Japanese Patent Application Laid Open No. 2019-8116, upon detection of a poor quality sheet, discharges to a purge tray the poor quality sheet and the printed sheets succeeding this poor quality sheet, and pauses the printing. Then, an operator of the image forming apparatus moves the sheets discharged into the purge tray to a sheet insertion tray and instructs the image forming apparatus to start the printing. Then, the image forming apparatus performs a recovery function in such a way that for each of the sheets moved to the sheet insertion tray, if the sheet is of poor quality, the image forming apparatus reprints an image corresponding to the poor quality sheet on a new sheet and discharges the new sheet into the predetermined tray, and if the sheet is of normal quality, the image forming apparatus discharges the normal quality sheet as is into the predetermined tray.

### SUMMARY

The image forming apparatus described in Japanese Patent Application Laid Open No. 2019-8116 provides the recovery function while reducing the wasted sheets. However, the human operator is required to move the sheets on the purge tray to the sheet insertion tray. Thus, the process for the recovery function is labor intensive. Moreover, the image forming apparatus pauses until the operator has moved the sheets discharged into the purge tray to the sheet insertion tray. Accordingly, if it takes a time for the operator to notice the pause of the image forming apparatus, the time for printing is prolonged.

The present invention has been made in view of such a background and it is an object of the present invention to provide an image forming apparatus and a control method that provides a recovery function while reducing wasted sheets.

To achieve the abovementioned object, according to an aspect of the present invention, an image forming apparatus reflecting one aspect of the present invention forms images on a series of sheets and includes: an image forming processor to form an image on each sheet; a reader to read each sheet and to output read data; an inspector to determine a quality of each sheet using the read data; and a controller to, when one or ones of the series of sheets are determined as not satisfying a predetermined quality criteria, discharge each of the one or ones of the series of sheets into a second tray other than a first tray specified in a print job. When copies specified in the print job are each constituted by one of the series of sheets and at least one sheet of the series of sheets is on a transport path as at least one remaining sheet, the controller processes each of the at least one remaining sheet in such a way that if the remaining sheet satisfies the predetermined quality criteria, the controller discharges the remaining sheet into the first tray.

Moreover, to achieve the abovementioned object, according to an aspect of the present invention, a method reflecting one aspect of the present invention is to be performed by an image forming apparatus that forms images on a series of sheets. The method includes steps of: forming an image on each sheet; reading each sheet to output read data; inspecting quality of each sheet using the read data; when one or ones of the series of sheets are determined as not satisfying a predetermined quality criteria, discharging each of the one or ones of the series of sheets into a second tray other than a first tray specified in a print job; and when copies specified in the print job are each constituted by one of the series of sheets and at least one sheet of the series of sheets is on a transport path as at least one remaining sheet, processing each of the at least one remaining sheet in such a way that if the remaining sheet satisfies the predetermined quality criteria, the remaining sheet is discharged into the first tray.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating the general configuration of an image forming apparatus according to an embodiment.

FIG. 2 is a functional diagram of the image forming apparatus according to the embodiment.

FIG. 3 is a diagram illustrating a state of sheets in the image forming apparatus according to the embodiment in the event of detecting an abnormality in the quality of printing in a print job including multiple copies each consisting of one page.

FIG. 4 is an explanatory diagram (1) for explaining a recovery process of the image forming apparatus according to the embodiment after detecting the abnormality in the quality of printing in the print job including multiple copies each consisting of one page.

FIG. 5 is an explanatory diagram (2) for explaining the recovery process of the image forming apparatus according to the embodiment after detecting the abnormality in the quality of printing in the print job including multiple copies each consisting of one page.

FIG. 6 is a diagram illustrating a state of sheets in the image forming apparatus according to the embodiment after restarting printing in the print job including multiple copies each consisting of one page.

FIG. 7 is a diagram illustrating a state of sheets in the image forming apparatus according to the embodiment in the event of detecting an abnormality in the quality of printing in a print job including multiple copies each consisting of two pages.

FIG. 8 is an explanatory diagram (1) for explaining a recovery process of the image forming apparatus according to the embodiment after detecting the abnormality in the quality of printing in the print job including multiple copies each consisting of two pages.

FIG. 9 is an explanatory diagram (2) for explaining the recovery process of the image forming apparatus according to the embodiment after detecting the abnormality in the quality of printing in the print job including multiple copies each consisting of two pages.

FIG. 10 is an explanatory diagram (3) for explaining the recovery process of the image forming apparatus according to the embodiment after detecting the abnormality in the quality of printing in the print job including multiple copies each consisting of two pages.

FIG. 11 is a diagram illustrating a state of sheets in the image forming apparatus according to the embodiment after restarting printing in the print job including multiple copies each consisting of two pages.

FIG. 12 is a flowchart of a recovery process of the image forming apparatus according to the embodiment.

### DETAILED DESCRIPTION OF EMBODIMENTS

Hereinafter, an embodiment of the present invention will be described with reference to the drawings. However, the scope of the invention is not limited to the disclosed embodiment.

The image forming apparatus reads the images printed on sheets of paper (hereinafter referred to as sheets) and upon detection of a poor quality sheet, determines, for each of the remaining sheets remaining on the transport path, whether the image printed on the remaining sheet is normal and the remaining sheet corresponds to a sheet that is to be outputted next after the sheet most recently discharged into a predetermined tray, and if the determination is positive, outputs the remaining sheet to the predetermined tray. If the remaining sheet is of poor quality (abnormal quality) or if the remaining sheet is not the sheet that is to be outputted next after the sheet most recently discharged into the predetermined tray, the image forming apparatus discharges the remaining sheet to a purge tray.

Specifically, the sheet that is to be outputted next after the sheet most recently discharged into the predetermined tray is, for example, if the most recently discharged sheet corresponds to the second page, one corresponding to the third page. In a case of a print job including multiple copies each consisting of two pages, if the most recently discharged sheet corresponds to the second page of a copy, the sheet that is to be outputted next corresponds to the first page of the next copy. In a case of double-sided printing, when the most recently discharged sheet corresponds to the third and fourth pages, the sheet that is to be outputted next corresponds to the fifth and sixth pages.

With this processing, the image forming apparatus according to the present embodiment makes it possible to perform the recovery function without human intervention. In other words, the image forming apparatus can discharge the sheets of copies whose number is specified in the print job to the predetermined tray in a correct order.

### General Configuration

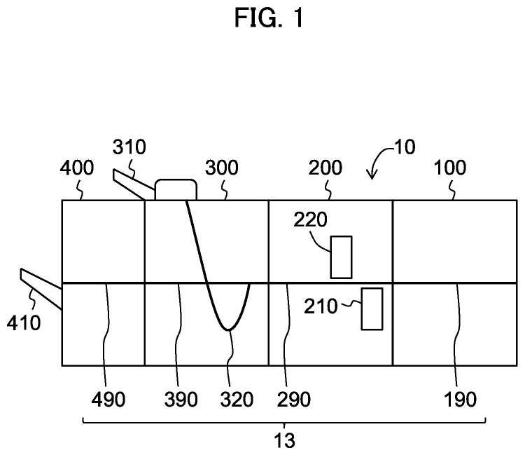

FIG. 1 is a diagram illustrating the general configuration of an image forming apparatus 10 according to a present embodiment. The image forming apparatus 10 includes: a main apparatus 100, an inspection device 200, an inspection transport relay device 300, and a sheet discharge device 400. A transport path 13 includes a transport path 190 in the main apparatus 100, a transport path 290 in the inspection device 200, transport paths 320 and 390 in the inspection transport relay device 300, and a transport path 490 in the sheet discharge device 400. The transport path 13 is a path through which sheets provided from a paper feed tray (not shown) of the main apparatus 100 are transported to a sheet discharge tray 410 of the sheet discharge device 400. While a sheet is being transported through the transport path 13, an image is formed (printed) on the sheet by the main apparatus 100 and is read by readers 210 and 220 of the inspection device 200. If the read result of the image formed on the sheet read by the readers 210 and 220 is of poor quality, the sheet is transported through the transport path 320, a part of the transport path 13, to be discharged into a purge tray 310.

### Functional Configuration

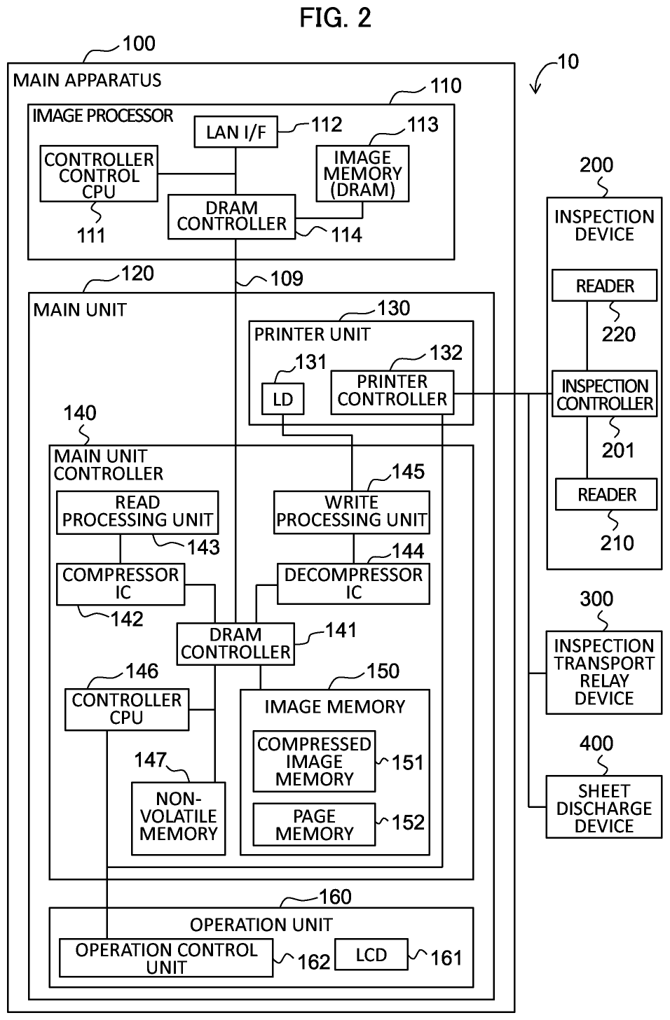

FIG. 2 is a functional diagram of the image forming apparatus 10 according to the present embodiment. The main apparatus 100 includes an image processor 110 and a main unit 120.

The image processor 110 has an image processing function or the like by which image data is generated from print job data sent by an external terminal, such as a personal computer, via a network such as a local area network (LAN). The image processor 110 includes: a controller control central processing unit (CPU) 111 that carries out image processing; a LAN interface 112 (denoted as “LAN I/F” in FIG. 2) interfacing with a LAN; an image memory 113 that stores generated image data or the like; and a dynamic random access memory (DRAM) controller 114 that inputs/outputs data to/from the image memory 113 and transfers image data to the main unit 120.

The main unit 120 includes: a printer unit 130; a main unit controller 140; and an operation unit 160.

The printer unit 130 includes: a laser diode (LD) 131 that emits laser light to a photosensitive drum by being on-off controlled according to the image data and thereby writes a latent image on the photosensitive drum; and a printer controller 132 that controls the overall operations of the printer unit 130. Among others, the printer unit 130 includes, although not shown in the drawings, a development unit that develops the latent image on the photosensitive drum as a toner image, a transfer unit that transfers the toner image to a sheet on the transport path 190 (see FIG. 1), a fixing unit that fixes the toner image on the sheet as the image printed on the sheet, and paper feed trays. That is, the printer unit 130 has a function of printing (forming an image) on the sheet on the transport path 13.

The operation unit 160 includes a liquid crystal display (LCD) 161 (denoted as “LCD” in FIG. 2) and an operation control unit 162. The LCD 161 is equipped with a touch panel on its display and is used to present various (operation) screens and to detect the position at which an operator has touched.

The operation control unit 162 is constituted by a central processing unit (CPU) and displays various screens on the display of the LCD 161 to present the status and/or settings of the image forming apparatus 10, information pertaining to print jobs, and buttons. The operation unit 160 accepts the operations from the operator and instructs the main unit controller 140 to output the print jobs specified by the operations.

The main unit controller 140 controls the operations of the main unit 120 and includes: a DRAM controller 141, a compressor integrated circuit (IC) 142, a read processing unit 143, a decompressor IC 144, a write processing unit 145, a controller CPU 146, a non-volatile memory 147, and an image memory 150.

The DRAM controller 141 performs inputting/outputting data into/from the image memory 150 and receiving image data from the DRAM controller 114 of the image processor 110. Incidentally, the DRAM controllers 114 and 141 are connected via peripheral component interconnect (PCI) bus 109.

The compressor IC 142 compresses the image data and the decompressor IC 144 decompresses the compressed image data to the original image data. The image memory 150 includes: a compressed image memory 151 that stores the image data compressed by the compressor IC 142; and a page memory 152 that stores non-compressed image data on a per-page basis.

The read processing unit 143 performs enlarging and/or mirroring of the image data. The write processing unit 145 outputs a signal for turning on/off the LD 131 according to the image data read from the compressed image memory 151 and decompressed by the decompressor IC 144, in conjunction with the timing of the operations of the printer unit 130.

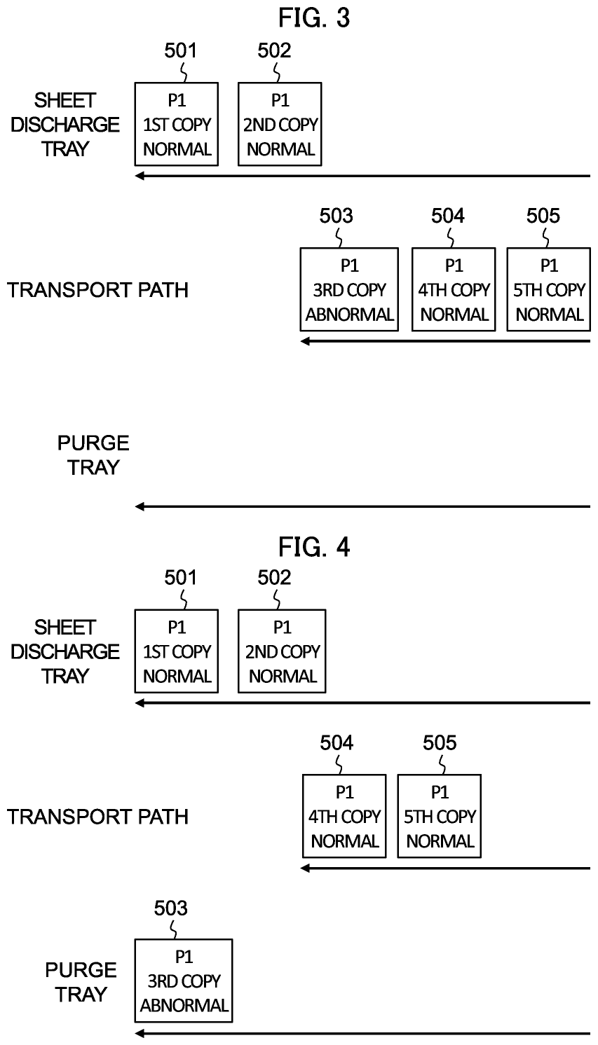

The controller CPU 146 is constituted by a CPU and controls the whole of the image forming apparatus 10. A description will be given of the recovery process carried out by the controller CPU 146 with reference to the below-described FIGS. 3 to 12. The controller CPU 146 controls the entire print process including printing on the sheets and transporting and discharging the sheets. The management to be carried out by the controller CPU 146 includes editing and execution of the print jobs, determination of the tray into which the sheets are to be discharged, and keeping track of up to which page of which copy has been completed and discharged.

The non-volatile memory 147 is a storage device to store user data, system data, and the like that are kept even after the power of the main apparatus 100 is turned off.

The inspection device 200 includes: an inspection controller 201 that controls the operations of the inspection device 200; readers 210 and 220 that read images on the sheets; and the transport path 290. The transport path 290 is connected to the transport path 190 of the main apparatus 100 and to the transport path 390 of the inspection transport relay device 300. The transport path 290 transports the sheets from the main apparatus 100 to the inspection transport relay device 300.

The transport path 290 is provided with the reader 210, which reads the image on the lower surface of each sheet, and the reader 220, which reads the image on the upper surface of each sheet. The readers 210 and 220 each, for example, include a line sensor including a Complementary Metal-Oxide-Semiconductor (CMOS) sensor or a Charged-Coupled Device (CCD) sensor.

The inspection controller 201 controls the readers 210 and 220 to store the image data read by the readers 210 and 220 temporarily in a memory not shown and determines the quality of the images. More in detail, the inspection controller 201 compares the image data read by the reader 210 and 220 and image data received from the main unit 120 as a reference, and determines that the image quality is normal if the images on the sheet satisfies predetermined quality criteria and that the image quality is abnormal if the images on the sheet fail to satisfy the predetermined quality criteria. The criteria as to whether the images have predetermined quality can be set as appropriate. The inspection controller 201 transmits the result of the normal/abnormal determination to the main unit 120.

### Recovery Process (One Sheet Per Copy)

Hereinbelow, a description will be given of the recovery process performed by the controller CPU 146 in a case of a print job including multiple copies each consisting of one page. Assume that this print job is to be performed by single-sided printing and the printed sheets are to be discharged into a sheet discharge tray 410 (see FIG. 1) specified in the print job.

When the inspection controller 201 detects an abnormality in the quality of printing (abnormality of image), the image forming apparatus 10 pauses the printing. Hereinbelow, a description will be given of the recovery process performed by the image forming apparatus 10 after the detection of the abnormality in the quality of printing.

FIG. 3 is a diagram illustrating a state of sheets in the image forming apparatus according to the embodiment in the event of detecting an abnormality in the quality of printing in a print job including multiple copies each consisting of one page. The left-pointing arrows represent the flows of sheets 501 to 505. For example, the arrow presented on the upper level represents that the sheets 501 and 502 have been discharged into the sheet discharge tray in this order. The arrow presented on the middle level represents that the sheets 503 to 505 have been transported on the transport path 13.

The sheet 501 of the first copy and the sheet 502 of the second copy have been discharged into the sheet discharge tray 410. On the transport path 13, there are sheets 503 to 505 as remaining sheets. Now, assume that an abnormality is detected on the sheet 503 of the third copy, and that the sheets 504 and 505 of the fourth and fifth copies are normal. In such a case, the controller CPU 146 controls the transport path 13 to discharge the abnormal sheet 503 into the purge tray 310 (see FIG. 1).

FIG. 4 is an explanatory diagram (1) for explaining a recovery process of the image forming apparatus according to the embodiment after detecting the abnormality in the quality of printing in the print job including multiple copies each consisting of one page. The sheet 503 (see FIG. 3), which was on the transport path 13, has been discharged into the purge tray 310. On the transport path 13, there remain the sheets 504 and 505, which are of normal quality. The sheet 502 most recently discharged into the sheet discharge tray 410 corresponds to the first page of the second copy. The next-in-sequence sheet to be outputted corresponds to the first page of the third copy. The sheet 504 has been printed as the first page of the fourth copy. However, the image printed on the sheet 504 is the same as that to be printed on the first page of the third copy. Therefore, the sheet 504 can be the next-in-sequence sheet to be outputted to the sheet discharge tray 410. For this reason, the controller CPU 146 discharges the sheet 504 into the sheet discharge tray 410 as the first page of the third copy. This process is applied to the sheet 505 in the same manner. That is, the controller CPU 146 discharges the sheet 505 into the sheet discharge tray 410 as the first page of the fourth copy.

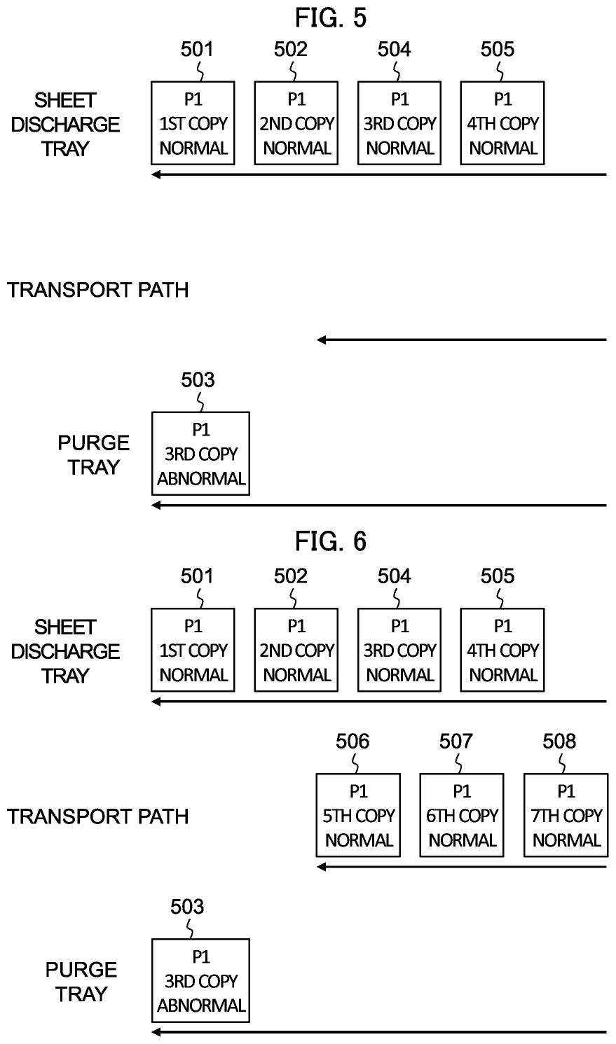

FIG. 5 is an explanatory diagram (2) for explaining the recovery process of the image forming apparatus according to the embodiment after detecting the abnormality in the quality of printing in the print job including multiple copies each consisting of one page. The sheets 504 and 505 have been discharged into the sheet discharge tray 410. In the state illustrated in FIG. 5, all the remaining sheets have been discharged into the purge tray 310 or the sheet discharge tray 410 and there remains no sheet on the transport path 13. Subsequently, the controller CPU 146 restarts printing by the main apparatus 100 from the first page of the fifth copy, which is the next-in-sequence page to be outputted.

FIG. 6 is a diagram illustrating a state of sheets in the image forming apparatus according to the embodiment after restarting printing in the print job including multiple copies each consisting of one page. In this state, the printing has been started from the first page of the fifth copy, resulting in the sheets 506 to 508 being present on the transport path 13. The sheets 506 to 508 are of normal quality and will be discharged into the sheet discharge tray 410.

Hereinabove, the recovery process in the case of multiple copies each consisting of one page has been described. Even in a case of multiple copies each consisting of two pages printed by double-sided printing, one sheet is used for one copy and thus the recovery process in this case is similar to those illustrated in FIGS. 3 to 6.

### Recovery Process (Multiple Sheets Per Copy)

Next, a description will be given of the recovery process to be performed in a case of multiple copies each consisting of multiple sheets, by taking an example of a print job involving single-sided printing on multiple copies each consisting of two pages.

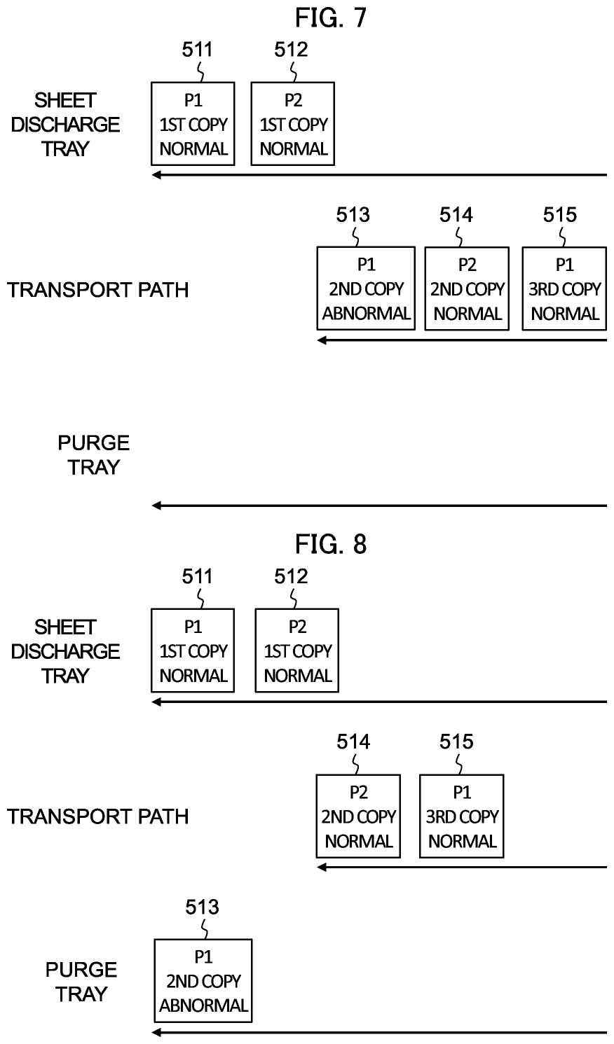

FIG. 7 is a diagram illustrating a state of sheets in the image forming apparatus according to the embodiment in the event of detecting an abnormality in the quality of printing in a print job including multiple copies each consisting of two pages. In this state, the sheet 511 for the first page of the first copy and the sheet 512 for the second page of the first copy have been discharged into the sheet discharge tray 410. The remaining sheets on the transport path 13 are the sheet 513 for the first page of the second copy, the sheet 514 for the second page of the second copy, and the sheet 515 for the first page of the third copy. Now, assume that an abnormality has been detected on the sheet 513 and that the sheets 514 and 515 are normal. In this case, the controller CPU 146 controls the transport path 13 to discharge the abnormal sheet 513 into the purge tray 310.

FIG. 8 is an explanatory diagram (1) for explaining a recovery process of the image forming apparatus according to the embodiment after detecting the abnormality in the quality of printing in the print job including multiple copies each consisting of two pages. The sheet 513 (see FIG. 7), which was on the transport path 13, has been discharged into the purge tray 310. On the transport path 13, there remain the sheets 514 and 515, which are of normal quality. The sheet 512 most recently discharged into the sheet discharge tray 410 corresponds to the second page of the first copy. The next-in-sequence sheet to be outputted corresponds to the first page of the second copy. Although the sheet 514 is normal, it corresponds to the second page and is not the next-in-sequence page to be outputted. If it is discharged into the sheet discharge tray 410, the sheets on the sheet discharge tray 410 get in wrong order. To avoid this situation, the controller CPU 146 controls the transport path 13 to discharge the sheet 514 into the purge tray 310.

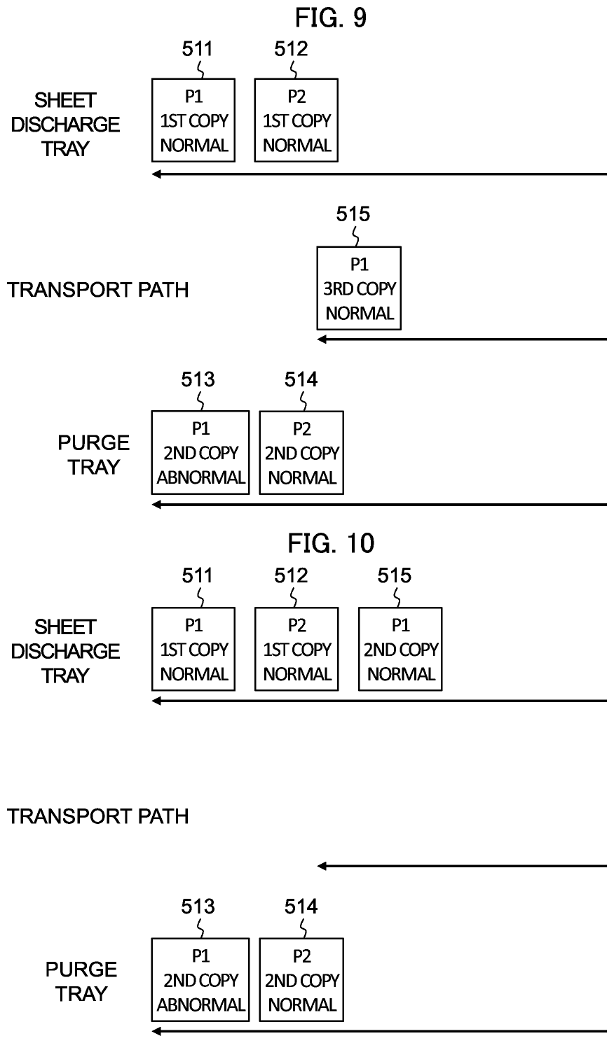

FIG. 9 is an explanatory diagram (2) for explaining the recovery process of the image forming apparatus according to the embodiment after detecting the abnormality in the quality of printing in the print job including multiple copies each consisting of two pages. The sheet 514 (see FIG. 8), which was on the transport path 13, has been discharged into the purge tray 310. On the transport path 13, there remains the sheet 515, which is of normal quality. The sheet 512, which has been most recently discharged into the sheet discharge tray 410, corresponds to the second page of the first copy. The next-in-sequence sheet to be outputted corresponds to the first page of the second copy. The sheet 515 has been printed as the first page of the third copy. However, the image printed on the sheet 515 is the same as that to be printed on the first page of the second copy. Therefore, the sheet 515 can be the sheet that is to be outputted next to the sheet discharge tray 410. For this reason, the controller CPU 146 discharges the sheet 515 into the sheet discharge tray 410 as the first page of the second copy.

FIG. 10 is an explanatory diagram (3) for explaining the recovery process of the image forming apparatus according to the embodiment after detecting the abnormality in the quality of printing in the print job including multiple copies each consisting of two pages. The sheet 515 has been discharged into the sheet discharge tray 410. In this state illustrated in FIG. 10, each of all the remaining sheets has been discharged into the purge tray 310 or into the sheet discharge tray 410 and there remains no sheet on the transport path 13. Subsequently, the controller CPU 146 restarts printing by the main apparatus 100 from the second page of the second copy, which is the next-in-sequence page to be outputted.

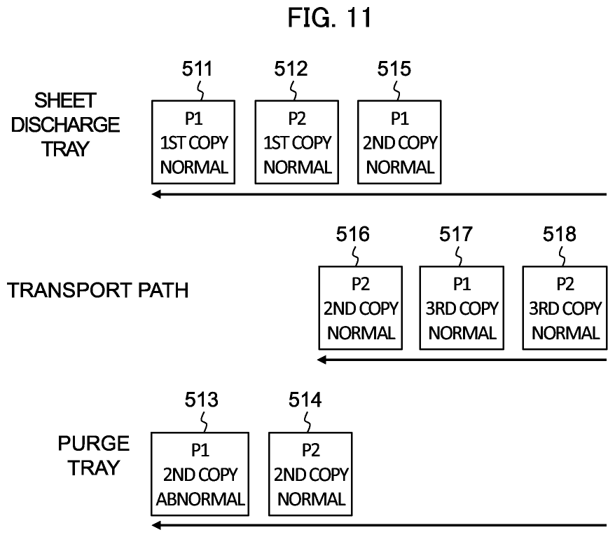

FIG. 11 is a diagram illustrating a state of sheets in the image forming apparatus according to the embodiment after restarting printing in the print job including multiple copies each consisting of two pages. In this state, the printing has been started from the second page of the second copy and there are sheets 516 to 518 on the transport path 13. The sheets 516 to 518 are of normal quality and will be discharged into the sheet discharge tray 410.

Hereinabove, the recovery process in a case of multiple copies each consisting of two pages has been described. Even in a case of multiple copies each consisting of multiple sheets, such as a case of multiple copies each consisting of three or more pages or a case of multiple copies each consisting of three or more pages with double-sided printing, the recovery processes illustrated in FIGS. 7 to 11 are applicable to such cases by reading the second page of a copy as the second sheet of the copy.

### Flow of Recovery Process

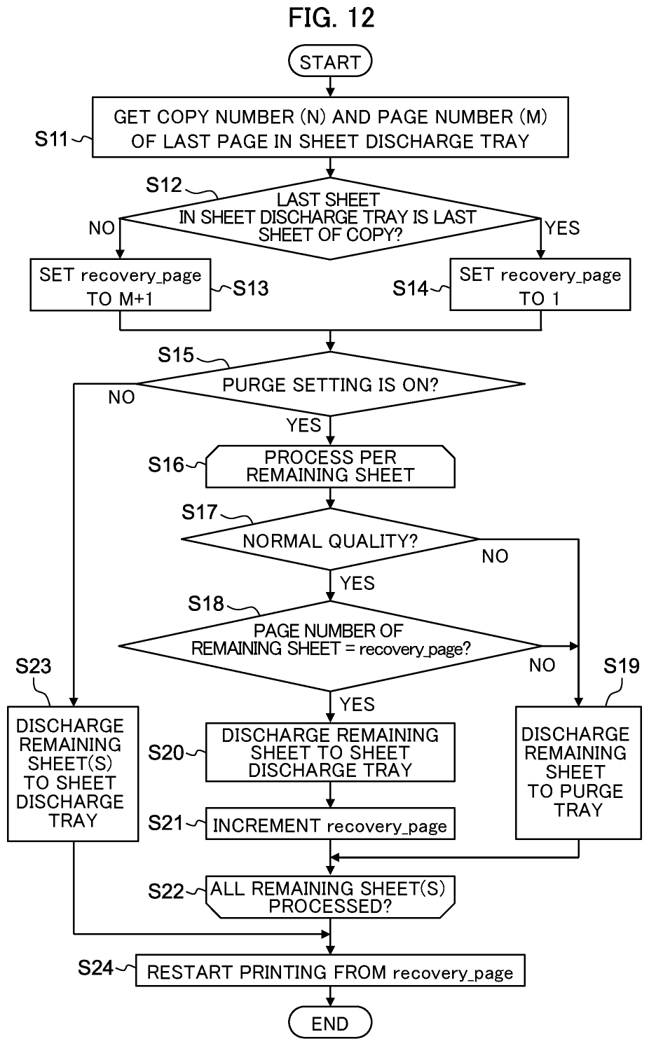

FIG. 12 is a flowchart of the recovery process according to the embodiment. The recovery process which is to be performed by the controller CPU 146 after, in a print job of multiple copies, detecting an abnormality in the quality of a sheet and pausing printing is described with reference to FIG. 12. It should be noted that although the description below is given under the assumption that one page is printed per one sheet by single-sided printing, the description applies also to the cases of double-sided printing.

At step S11, the controller CPU 146 gets the sequential number of the copy and the sequential number of the page which correspond to the last sheet (sheet having been most recently discharged) on the sheet discharge tray 410. In this description, we assume that up to M-th page of N-th copy have been discharged.

At step S12, the controller CPU 146 determines whether the last sheet on the sheet discharge tray 410 corresponds to the last page of a copy. If the sheet corresponds to the last page (YES at step S12), the controller CPU 146 proceeds to step S14, and otherwise (NO at step S12) proceeds to step S13.

At step S13, the controller CPU 146 sets a variable recovery_page to M+1. The variable recovery_page represents the page number of the page to be outputted next to the sheet discharge tray 410 (the sequential number of the next-in-sequence page to be outputted).

At step S14, the controller CPU 146 sets recovery_page to 1.

At step S15, the controller CPU 146 determines whether a purge setting has been set to ON. If the purge setting has been set to ON (YES at step S15), the controller CPU 146 proceeds to step S16, and otherwise (NO at step S15) proceeds to step S23. Here, when the purge setting is set to ON, a recovery process is to be performed.

At step S16, the controller CPU 146 performs steps S17 to S21 for each of the remaining sheets on the transport path 13.

At step S17, the controller CPU 146 proceeds to step S18 if the current remaining sheet is of normal quality (YES at step S17) and proceeds to step S19 if the current remaining sheet is of abnormal quality (NO at step S17). The controller CPU 146 gets the result of the determination of normal/abnormal quality from the inspection controller 201 (see FIG. 2).

At step S18, the controller CPU 146 proceeds to step S20 if the page number of the current sheet corresponds to the value of recovery_page (YES at step S18), and otherwise (NO at step S18) proceeds to step S19.

At step S19, the controller CPU 146 discharges the current remaining sheet into the purge tray 310.

At step S20, the controller CPU 146 discharges the current remaining sheet into the sheet discharge tray 410.

At step S21, the controller CPU 146 increments the value of recovery_page. More accurately, when the value of recovery_page corresponds to the last page of the current copy, the controller CPU 146 sets the value of recovery_page to 1; and otherwise the controller CPU 146 increments the value of recovery_page.

At step S22, if the controller CPU 146 has completed steps S17 to S21 for all the remaining sheets on the transport path 13, the controller CPU 146 proceeds to step S24, and otherwise returns to step S17 to process the first sheet of the current remaining sheets.

At step S23, the controller CPU 146 discharges all the remaining sheets into the sheet discharge tray 410.

At step S24, the controller CPU 146 restart printing from the page corresponding to the value of recovery_page.

### Features of Recovery Process

When an abnormality of an image is detected, the image forming apparatus 10 starts the recovery process. In detail, for each of the remaining sheets on the transport path 13, if the remaining sheet is of normal quality (see step S17) and if the remaining sheet corresponds to the sheet that is to be outputted next after the sheet most recently discharged into the sheet discharge tray 410 (i.e., corresponds to recovery_page; see steps S12 to S14 and S21) (see step S18), the controller CPU 146 discharges the remaining sheet into the sheet discharge tray 410 (see step S20). If the remaining sheet is of abnormal quality or if the remaining sheet does not correspond to the next-in-sequence sheet to be outputted, the controller CPU 146 discharges the remaining sheet into the purge tray 310 (see step S19).

Having completed the recovery process, the image forming apparatus 10 restarts the printing from the next-in-sequence sheet to be outputted (see step S24).

By the recovery process, the order of the sheets discharged into the sheet discharge tray 410 is always correct and copies whose number is specified in the print job are printed and discharged. The recovery process is processed without human intervention and is completed even in the absence of an operator, and then the printing is restarted. In addition, if a remaining sheet is of normal quality and is the next-in-sequence sheet to be outputted, the image forming apparatus 10 discharges the remaining sheet into the sheet discharge tray 410, leading to a reduction in the number of wasted sheets discharged into the purge tray 310.

### Modification: Image Inspection

According to the above-described embodiment, the inspection device 200 inspects images. The main apparatus 100 may inspect the images. Specifically, the images read by the readers 210 and 220 may be transmitted to the main unit controller 140 and then the controller CPU 146 may compare them with reference images. Alternatively, the main apparatus 100 may include a processor other than the controller CPU 146 and the processor may perform the comparison to determine the normal/abnormal quality.

### Other Modifications

The invention is not limited to the above-described embodiments and can be properly modified within the aim of the present invention. According to the above-described embodiment, sheets of normal quality are discharged into the sheet discharge tray 410. However, the destination tray may be another tray specified in the print job. In addition, as to the purge tray 310, the destination for purging may be another tray. Moreover, the sheets may be cut and discharged into a waste box. The sheet discharge tray 410 and the purge tray 310 may be switched over.

At step S23 illustrated in FIG. 12, all the remaining sheets may be discharged into the purge tray 310. In this case, all the remaining sheets are wasted but the sheets discharged into the sheet discharge tray 410 are always in correct order.

It should be noted that the program steps to be recorded in a recording medium and carried out for executing the methods described in the specification include steps chronologically executed and steps which are not necessarily chronologically executed but are concurrently or separately executed. For example, steps S17 and S18 illustrated in FIG. 12 may be switched over.

Although a certain embodiment of the present invention has been described and illustrated in detail, the disclosed embodiment is made for purposes of illustration and example only and not limitation. The present invention can be carried out in various modes and the embodiments can be modified by omitting and/or replacing certain constituent elements as appropriate without departing from the gist of the present invention. These embodiments and modifications thereof are covered by the scope or gist of the present invention described in the present specification. The scope of the invention should be interpreted by terms of the appended claims.

What is claimed is:

1. An image forming apparatus to form images on a series of sheets, the image forming apparatus comprising:
an image forming processor to form an image on each sheet;
a reader to read each sheet and to output read data;
an inspector to determine a quality of each sheet using the read data; and
a controller to, when one or ones of the series of sheets are determined as not satisfying a predetermined quality criteria, discharge each of the one or ones of the series of sheets into a second tray other than a first tray specified in a print job,
wherein when copies specified in the print job are each constituted by one of the series of sheets and at least one sheet of the series of sheets is on a transport path as at least one remaining sheet, the controller processes each of the at least one remaining sheet in such a way that if the remaining sheet satisfies the predetermined quality criteria, the controller discharges the remaining sheet into the first tray.

2. An image forming apparatus to form images on a series of sheets, the image forming apparatus comprising:
an image forming processor to form an image on each sheet;
a reader to read each sheet and to output read data;
an inspector to determine a quality of each sheet using the read data; and
a controller to, when one or ones of the series of sheets are determined as not satisfying a predetermined quality criteria, discharge each of the one or ones of the series of sheets into a second tray other than a first tray specified in a print job,
wherein when copies specified in the print job are each constituted by plural ones of the series of sheets and at least one sheet of the series of sheets is on a transport path as at least one remaining sheet, the controller processes each of the at least one remaining sheet in such a way that if the remaining sheet satisfies the predetermined quality criteria and the remaining sheet corresponds to a sheet that is to be outputted next after a sheet most recently discharged into the first tray, the controller discharges the remaining sheet into the first tray.

3. The image forming apparatus according to claim 2,
wherein the sheet most recently discharged into the first tray is a first sheet belonging to a first copy, and
wherein the sheet that is to be outputted next after the sheet most recently discharged into the first tray is:
when the first sheet is a last sheet of the first copy, an initial sheet of a copy that is next in sequence to the first copy;
and when the first sheet is different from the last sheet of the first copy, a sheet belonging to the first copy and being next in sequence to the first sheet.

4. The image forming apparatus according to claim 1,
wherein after all of the at least one remaining sheet have been discharged, the controller causes the image forming processor to form an image different from an image that is to be formed on a sheet that is next in sequence to a sheet on which the controller has most recently formed an image.

5. The image forming apparatus according to claim 4,
wherein when the copies specified in the print job are each constituted by one of the series of sheets, after all of the at least one remaining sheet have been discharged, the controller causes the image forming processor to form images from copies succeeding a copy most recently discharged into the first tray.

6. The image forming apparatus according to claim 4,
wherein when the copies specified in the print job are each constituted by plural ones of the series of sheets, after all of the at least one remaining sheets have been discharged, the controller causes the image forming processor to form an image from a sheet that is to be outputted next after a sheet most recently discharged into the first tray.

7. The image forming apparatus according to claim 2,
wherein after all of the at least one remaining sheet have been discharged, the controller causes the image forming processor to form an image different from an image that is to be formed on a sheet that is next in sequence to a sheet on which the controller has most recently formed an image.

8. The image forming apparatus according to claim 7,
wherein when the copies specified in the print job are each constituted by one of the series of sheets, after all of the at least one remaining sheet have been discharged, the controller causes the image forming processor to form images from copies succeeding a copy most recently discharged into the first tray.

9. The image forming apparatus according to claim 7,
wherein when the copies specified in the print job are each constituted by plural ones of the series of sheets, after all of the at least one remaining sheets have been discharged, the controller causes the image forming processor to form an image from the sheet that is to be outputted next after the sheet most recently discharged into the first tray.

10. A method to be performed by an image forming apparatus that forms images on a series of sheets, the method comprising steps of:
forming an image on each sheet;
reading each sheet to output read data;
inspecting quality of each sheet using the read data;
when one or ones of the series of sheets are determined as not satisfying a predetermined quality criteria, discharging each of the one or ones of the series of sheets into a second tray other than a first tray specified in a print job; and
when copies specified in the print job are each constituted by one of the series of sheets and at least one sheet of the series of sheets is on a transport path as at least one remaining sheet, processing each of the at least one remaining sheet in such a way that if the remaining sheet satisfies the predetermined quality criteria, the remaining sheet is discharged into the first tray.

11. A method to be performed by an image forming apparatus that forms images on a series of sheets, the method comprising steps of:
forming an image on each sheet;
reading each sheet to output read data;
inspecting a quality of each sheet using the read data;
when one or ones of the series of sheets are determined as not satisfying a predetermined quality criteria, discharging each of the one or ones of the series of sheets into a second tray other than a first tray specified in a print job; and
when copies specified in the print job are each constituted by plural ones of the series of sheets and at least one sheet of the series of sheets is on a transport path as at least one remaining sheet, processing each of the at least one remaining sheet in such a way that if the remaining sheet satisfies the predetermined quality criteria and the remaining sheet corresponds to a sheet that is to be outputted next after a sheet most recently discharged into the first tray, the controller discharges the remaining sheet into the first tray.
